(19) United States
(12) Patent Application Publication
(10) Pub. No.: US 2015/0203743 A1
(43) Pub. Date: Jul. 23, 2015

(54) METHODS FOR TREATING SUBTERRANEAN FORMATIONS

(71) Applicant: OILFLOW SOLUTIONS INC., Calgary (GB)

(72) Inventors: Philip Fletcher, Cambridgeshire (GB); Cory Jaska, Toronto (CA); Guy Mallory Bolton, Yorkshire (GB)

(73) Assignee: OILFLOW SOLUTIONS INC., Calgary (GB)

(21) Appl. No.: 14/426,129

(22) PCT Filed: Sep. 2, 2013
(86) PCT No.: PCT/GB2013/052294

§ 371 Date: Mar. 4, 2015

(30) Foreign Application Priority Data
Sep. 7, 2012 (GB) 1216004.0

(51) Int. Cl. C09K 8/68; E21B 43/267; C09K 8/80; E21B 43/26

(52) U.S. Cl. CPC C09K 8/68; E21B 43/26; E21B 43/267; C09K 8/80

(57) ABSTRACT

A method of fracturing a subterranean formation using a formulation comprising oil, polyvinylalcohol, water and, optionally, a proppant. The method involves introducing the formulation into the formation at a pressure sufficient to fracture the formation.

This invention relates to subterranean formations and particularly, although not exclusively, relates to fracturing subterranean formations. The invention also provides a method of increasing the viscosity of an oil and a formulation having increased viscosity and/or for use in fracturing subterranean formations.

Hydrocarbons, such as oil and natural gas, are obtained from a subterranean geologic formation (i.e. a “reservoir”) by drilling a wellbore that penetrates the hydrocarbon-bearing formation. This provides a partial flowpath for the oil to reach the surface. In order for oil to be “produced”, that is travel from the formation to the wellbore (and ultimately to the surface), there must be a sufficiently unimpeded flowpath from the formation to the wellbore. This flowpath is through the formation rock which has pores of sufficient size, connectivity, and conductivity to provide a conduit for the oil and gas to move through the formation.

However, in many cases, the formation rock has low permeability and so needs to be “stimulated” to improve its conductivity. One known method of stimulation involves injecting chemicals through the wellbore and into the formation at pressures sufficient to actually fracture the formation, thereby creating a large flow channel through which hydrocarbons can more readily move from the formation and into the wellbore.

Hydraulic fracturing involves breaking or fracturing a portion of the strata surrounding the wellbore, by injecting a fluid into the wellbore directed at the face of the geologic formation at pressures sufficient to initiate and extend a fracture in the formation. More particularly, a fluid is injected through a wellbore; the fluid exits the wellbore through holes (perforations in the well casing) and is directed against the face of the formation (sometimes wells are completely openhole where no casing and therefore no perforations exist, so the fluid is injected through the wellbore and directly to the formation face) at a pressure and flow rate sufficient to overcome the minimum in situ stress to initiate and/or extend a fracture or fractures into the formation. Often, a fracture zone, i.e. a zone having multiple fractures, or cracks in the formation is/are created, through which hydrocarbon can more easily flow to the wellbore.

Fluid used in fracturing may include a solid component referred to as a proppant which is intended to remain within a fracture after the overburden pressure is released. The purpose of the proppant is two-fold; first, to hold the faces of the fracture apart; and, secondly, to provide a low impedance path within the fracture through which the reservoir fluid can flow into the wellbore. Fracture fluids are suitably able to carry solid particles so they can carry and/or suspend solid proppant and deposit it within the fracture.

A first known type of fracture fluid may comprise gelled oil systems which include a light hydrocarbon fluid, for example diesel oil. In order to increase the viscosity of the oil to allow it to suspend a proppant, the fluid includes a viscosifying agent. Such agents may comprise hydratable polymers which may be cross-linked to increase viscosity even further. However, when fracture fluids incorporating hydratable polymers are used downhole, the polymer may accumulate on or within the formation to form a polymeric filter cake which may plug pores and damage the formation if incompletely removed prior to hydrocarbon production.

There can, in general, be problems surrounding “cleanup” of a formation after use of a fracture fluid. Techniques for promoting cleanup often involve reducing the viscosity of the treatment fluid as much as practical so that it will more readily flow toward the wellbore. This is called “breaking” the fluid. Breaking agents, or “breakers” are specific to the type of treatment fluid being used. Gel breakers are commonly used for conventional polymer based fluids used in stimulation and other activities since leaving such a high viscosity fluid in the formation would result in a reduction of the formation permeability and, consequently, decrease in the well production. The most widely used breakers are oxidizers and enzymes. The breakers can be dissolved or suspended in the liquid (aqueous, non-aqueous or emulsion) phase of the treating fluid and exposed to the polymer throughout the treatment (added “internally”), or exposed to the fluid at some time after the treatment (added “externally”).

It is well known to use alkyl-phosphate-esters in fracture fluids. However, not all undesirable products can readily be removed with the clean up. Some can remain in the well and be dissolved in or carried by the oil produced by the well. In recent years, problems in downstream processing of crude oil have been encountered, such as plugging of the refinery towers which process the hydrocarbons. These plugging problems can cause build up in the refinery towers and their trays, and removal of such plugging requires shut-down of the affected towers. Upon investigation, the plugging materials have frequently been found to be phosphorous compounds, derived from alkyl-phosphate-esters.

A second known type of fracture fluids are referred to as slick water fracture fluids. These are the most commonly used systems due to the comparatively low cost of the fluids. Typically a slick water fracture fluid uses a subterranean or other water source as the base fluid. In order to generate the required pressures within the wellbore, sufficient to cause the subterranean formation to break, and have enough momentum to carry a propping agent without sedimentation of that agent, very large fluid flowing velocities are required. The very high velocities generated would normally cause very large frictional pressure losses in the transport medium (well tubing surface equipment and pumps). In order to reduce the frictional pressure losses in the well tubing, drag reducing agents commonly referred to as “slicking” agents are added in very small concentrations to the water. The flow regimes encountered in water fracturing practices are characterized by Reynolds numbers that often exceed 100,000 and have been known to exceed 1,000,000.

A first type of slicking agent comprises surfactants which are dosed into a fluid so a highly localised concentration (above the critical micelle concentration) accumulates within the water/wall boundary layer in use. A second type of slicking agent comprises a long chain polymer such as a polyacrylamide which may be added in small concentrations. Due to the nature of the flow regime, localised relatively high concentrations of the additive are created within the water/wall boundary layer.

Both the surfactant and polymer systems described are limited to a lower boundary of operation below which insufficient radial energy is applied to the additives and therefore “slicking” does not occur. In addition, the performance of both systems may be degraded at very high flow rates due to the frictional energy experienced within the fluid. Additionally, long chain polymers are sensitive to their shear environment; at high flow rates and high shear, the polymers may degrade. If the density of long chain polymers is very low, impairment of the slicking effect is observed and therefore it has become common practice to overdose which incurs a significant cost penalty. Furthermore, both surfactants and polymer systems are susceptible to salinity of water. In view of the aforementioned problems, suitable slicking agents are determined on a case by case basis.

In one embodiment, the present invention is based on the use of certain polymers for increasing the viscosity of an oil used in a fracture fluid. Such polymers have been used previously in treatment of oils, for example in applicant's prior publication WO2005/040669. However, in the publication, the polymers are used for an opposite effect, namely to reduce viscosity of viscous fluids. In another embodiment, the present invention is also concerned with provision of slicking agents.

It is an object of the present invention to address problems associated with fracture fluids.

According to a first aspect of the invention, there is provided a method of fracturing a formation comprising:

(a) selecting a formulation comprising water and a polymeric material which includes —O— moieties pendent from a polymeric backbone;

(b) introducing the formulation into the formation at a pressure sufficient to fracture the formation.

Said polymeric backbone of said polymeric material preferably includes carbon atoms. Said carbon atoms are preferably part of —CH₂— moieties. Preferably, a repeat unit of said polymeric backbone includes carbon to carbon bonds, preferably C—C single bonds. Preferably, said polymeric material includes a repeat unit which includes a —CH₂— moiety. Preferably, said polymeric backbone does not include any —O— moieties, for example —C—O— moieties such as are found in an alkyleneoxy polymer, such as polyethyleneglycol. Said polymeric backbone is preferably not defined by an aromatic moiety such as a phenyl moiety such as is found in polyethersulphones. Said polymeric backbone preferably does not include any —S— moieties. Said polymeric backbone preferably does not include any nitrogen atoms. Said polymeric backbone preferably consists essentially of carbon atoms, preferably in the form of C—C single bonds.

Said —O— moieties are preferably directly bonded to the polymeric backbone—that is, suitably no intermediate atoms are provided between the backbone and the —O— moieties.

Said polymeric material preferably includes, on average, at least 10, more preferably at least 50, —O— moieties pendent from the polymeric backbone thereof. Said —O— moieties are preferably a part of a repeat unit of said polymeric material.

Preferably, said —O— moieties are directly bonded to a carbon atom in said polymeric backbone of said polymeric material, suitably so that said polymeric material includes a moiety (which is preferably part of a repeat unit) of formula:

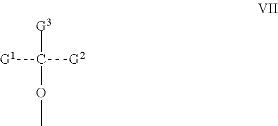

where G¹ and G² are other parts of the polymeric backbone and G³ is another moiety pendent from the polymeric backbone. Preferably, G³ represents a hydrogen atom.

Preferably, said polymeric material includes a moiety

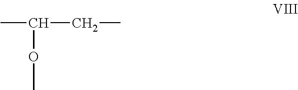

Said moiety VIII is preferably part of a repeat unit. Said moiety VIII may be part of a copolymer which includes a repeat unit which includes a moiety of a different type compared to moiety VIII. Suitably, at least 60 mole %, preferably at least 70 mole %, more preferably at least 80 mole % of said polymeric material comprises repeat units which comprise (preferably consist of) moieties VIII. Preferably, said polymeric material consists essentially of repeat units which comprise (preferably consist of) moieties VIII.

When said polymeric material includes a copolymer which includes units in addition to units VIII, said units may be vinyl units, suitably vinyl units incorporating amine, sulphonic, alkyl or formamide groups.

Said polymeric material suitably consists essentially of units of formula VIII and 20 mole % or less, preferably 10 mole % or less, more preferably 5 mole % or less, especially 0 mole % of other units.

Suitably, 60 mole %, preferably 80 mole %, more preferably 90 mole %, especially substantially all of said polymeric material comprises vinyl moieties.

Preferably, the free bond to the oxygen atom in moieties VII and/or VIII is bonded to a group R¹⁰ (so that the moiety pendent from the polymeric backbone of said polymeric material is of formula —O—R¹⁰). Preferably, group R¹⁰ comprises fewer than 10, more preferably fewer than 5, especially 3 or fewer carbon atoms. It preferably only includes atoms selected from carbon, hydrogen and oxygen atoms. R¹⁰ is preferably selected from a hydrogen atom and an alkylcarbonyl, especially a methylcarbonyl group. Preferably moiety —O—R¹⁰ in said polymeric material is an hydroxyl or acetate group.

Said polymeric material may include a plurality, preferably a multiplicity, of functional groups (which incorporate the —O— moieties described) suitably selected from hydroxyl and acetate groups. Said polymeric material preferably includes at least some groups wherein R¹⁰ represents an hydroxyl group. Suitably, at least 30%, preferably at least 50%, especially at least 80% of groups R¹⁰ are hydroxyl groups. Said polymeric material preferably includes a multiplicity of hydroxyl groups pendent from said polymeric backbone; and also includes a multiplicity of acetate groups pendent from the polymeric backbone.

The ratio of the number of acetate groups to the number of hydroxyl groups in said polymeric material is suitably in the range 0 to 3, is preferably in the range 0.5 to 1, is more preferably in the range 0.06 to 0.3, is especially in the range 0.06 to 0.25.

Preferably, substantially each free bond to the oxygen atoms in —O— moieties pendent from the polymeric backbone in said polymeric material is of formula —O—R¹⁰ wherein each group —OR¹⁰ is selected from hydroxyl and acetate.

Preferably, said polymeric material includes a vinyl alcohol moiety, especially a vinyl alcohol moiety which repeats along the backbone of the polymeric material. Said polymeric material preferably includes a vinyl acetate moiety, especially a vinylacetate moiety which repeats along the backbone of the polymeric material.

Said polymeric material suitably comprises at least 50 mole %, preferably at least 60 mole %, more preferably at least 70 mole %, especially at least 80 mole % of vinylalcohol repeat units. It may comprise less than 99 mole %, suitably less than 95 mole %, preferably 92 mole % or less of vinylalcohol repeat units. Said polymeric material suitably comprises 60 to 99 mole %, preferably 80 to 95 mole %, more preferably 85 to 95 mole %, especially 80 to 91 mole % of vinylalcohol repeat units.

Said polymeric material preferably includes vinylacetate repeat units. It may include at least 2 mole %, preferably at least 5 mole %, more preferably at least 7 mole %, especially at least 9 mole % of vinylacetate repeat units. It may comprise 30 mole % or less, or 20 mole % or less of vinylacetate repeat units. Said polymeric material preferably comprises 9 to 20 mole % of vinylacetate repeat units.

Said polymeric material is preferably not cross-linked.

Suitably, the sum of the mole % of vinylalcohol and vinylacetate repeat units in said polymeric material is at least 70 mole %, preferably at least 80 mole %, more preferably at least 90 mole %, especially at least 99 mole %.

Said polymeric material preferably comprises 70 to 95%, more preferably 80 to 95%, especially 85 to 91% hydrolysed polyvinylalcohol.

The weight average molecular weight (Mw) of said polymeric material may be less than 500,000, suitably less than 300,000, preferably less than 200,000, more preferably less than 100,000. In an especially preferred embodiment, the weight average molecular weight may be in the range 5,000 to 50,000. The weight average molecular weight of polymeric material may be less than 40,000, suitably is less than 30,000, preferably is less than 25,000. The Mw may be at least 5,000, preferably at least 10,000. The Mw is preferably in the range 5,000 to 25,000, more preferably in the range 10,000 to 25,000.

The viscosity of a 4 wt % aqueous solution of the polymeric material at 20° C. is preferably in the range 1.5-7 cP. In relation to said polymeric material, the viscosity of an aqueous solution and/or formulation as described herein may be assessed by Japanese Standards Association (JSA) JIS K6726 using a Type B viscometer, an Anton Paar MCR 300 or a Brookfield type viscometer.

The viscosity of a said 4 wt % aqueous solution of the polymeric material at 20° C. may be at least 2.0 cP, preferably at least 2.5 cP. The viscosity may be less than 6 cP, preferably less than 5 cP, more preferably less than 4 cP. The viscosity is preferably in the range 2 to 4 cP.

The number average molecular weight (Mₙ) of said polymeric material may be at least 5,000, preferably at least 10,000, more preferably at least 13,000. Mₙ may be less than 40,000, preferably less than 30,000, more preferably less than 25,000. The Mₙ is preferably in the range 5,000 to 25,000.

Weight average molecular weight may be measured by light scattering, small angle neutron scattering, x-ray scattering or sedimentation velocity.

Water for use in the treatment formulation may be derived from any convenient source. It may be potable water, surface water, sea water, aquifer water, deionised production water and filtered water derived from any of the aforementioned sources. Said water is preferably a brine, for example sea water or is derived from a brine such as sea water. The references to the amounts of water herein suitably refer to water inclusive of its components, e.g. naturally occurring components such as found in sea water. Water may include up to 6 wt % dissolved salts but suitably includes less than 4 wt %, 2 wt % or 1 wt % or less of dissolved salts which are naturally occurring in the water. It is preferred for a low salinity water to be used.

The method is suitably a method of hydraulically fracturing a subterranean formation which comprises contacting a subterranean formation with said formulation at a flow rate and pressure sufficient to produce or extend a fracture in the formation.

The method may include a step, suitably prior to step (b), of treating the formation with an acid formulation which may contain a dilute acid. This may be used to clear cement debris and/or provide an open conduit for the formulation used in step (b) by dissolving carbonate minerals and/or opening fractures near the wellbore.

Said formulation preferably includes one or more proppants. The formulation may be compatible with any common proppant size required. The proppant may have a size in the range 20-40 MESH. Said proppant(s) may be selected from sand, bauxite, man-made intermediate or high strength materials and glass beads. The proppant is arranged to restrict close down of a fracture on removal of the hydraulic pressure which caused the fracture.

The total weight of proppant(s) in said formulation is suitably in the range 5 wt % to 30 wt %. Preferably, the total weight of proppant(s) in said formulation is in the range 10 to 20 wt %.

Said formulation may include at least 5 wt %, suitably at least 10 wt %, preferably at least 15 wt %, more preferably at least 20 wt %, especially at least 25 wt % water. Said formulation may include less than 60 wt %, less than 50 wt % or less than 40 wt % water. The amount of water is suitably in the range 10 to 45 wt %, preferably 25 to 40 wt %.

Said formulation suitably includes an oil. It may include at least 10 wt %, preferably at least 30 wt %, more preferably at least 50 wt % of an oil. It may include less than 90 wt % or less than 80 wt % oil. Suitably, said formulation includes 55 to 90 wt % oil, preferably 55 to 75 wt % oil.

Said oil may comprise a fracture diesel oil or a vegetable oil, for example canola oil. Said oil preferably comprises a said fracture diesel oil. Said oil may have a vapour pressure at 20° C. in the range 20 to 70 mmHg. It may have a boiling point in the range 105° C. to 350° C. It may have a melting point in the range −100 to −25° C. It is preferably insoluble in water at 25° C. It may have a specific gravity at 15.6° C. in the range 0.6 to 0.9.

Said method may include the step of introducing a breaker into the formation, preferably before or after step (b). Said breaker may be arranged to destabilise the formulation introduced in step (b) and reduce its apparent viscosity, thereby facilitating its removal from the formation, suitably at an appropriate time.

Said formulation may include at least 500 kg of proppant material per m³ of said formulation. Said formulation may include 500-3000 kg of proppant material per m³ of said formulation.

The method may include a step (c) which follows step (b) and comprises introducing a second formulation into the formation at a pressure sufficient to fracture the formation. The second formulation may comprise a said polymeric material as described. Suitably, said second formulation includes the same polymeric material used in the formulation of step (a), suitably at the same concentration. In one embodiment, the method may comprise said step (c) wherein the second formulation includes one or more proppants as described above and wherein the formulation used in step (b) includes a lower total concentration of proppants compared to the concentration in said second formulation or, preferably, said formulation used in step (b) includes no proppants.

In a first embodiment, said formulation selected in step (a) comprising water and said polymeric material is used to increase the viscosity of said oil which is included in said formulation. For example, a sheared formulation (e.g. as described in Example 2 herein) comprising said formulation comprising water, polymeric material and oil may have a consistency index at 25° C. which is at least 50 times, or at least 100 times, the consistency index of the oil alone. This is illustrated and described further in Example 2 and the observation may be applied generally.

Said formulation described in (a) may include a particulate material (which is suitably not a proppant) which may be included to enhance stability of a formulation of water, polymeric material and oil. For example, 100% of said particulate material may pass through a mesh screen aperture size of 50 μm, for example 30 μm. Said particulate material is suitably inorganic; it may be silica based; it may comprise a flour; it may comprise a silica flour.

Where said formulation includes said particulate material described, said formulation may include 0-10 wt %, for example 0-6 wt % of said particulate material. In a preferred embodiment, said formulation includes 0.5 to 10 wt % of said particulate material.

Said formulation described in (a) may include less than 2 wt %, less than 1.5 wt % or 1.0 wt % or less of surfactants, for example surfactants having HLB values in the range 10 to 17.

Said formulation preferably has an apparent viscosity at 25° C. and a shear rate of 1 s⁻¹ of at least 100 cP, preferably at least 500 cP, more preferably at least 1000 cP, immediately prior to introduction into the formation.

In a second embodiment, said formulation selected in step (a) may be arranged to define a slick water fracture fluid. Such a fracture fluid may include drops of a hydrocarbon which are stabilised by an aqueous formulation of said polymeric material. Such stabilised drops may be added to a mass of moving water based fracture fluid.

According to a second aspect of the invention, there is provided a method of preparing a formulation for use in the method of the first aspect, the method comprising contacting an aqueous formulation of said polymeric material with an oil, optionally in the presence of one or more proppants.

The amounts of water, polymeric material and proppants may be as described in the first aspect.

The formulation prepared may have any feature of the formulation described according to the first aspect.

According to a third aspect of the invention, there is provided a formulation for use in the method of the first aspect, said formulation comprising water, said polymeric material, an oil and, optionally, one or more proppants.

The amounts of water, polymeric material and proppants may be as described in the first aspect.

The formulation may have any feature of the formulation described according to the first aspect.

According to a fourth aspect of the invention, there is provided a method of recovering oil from a subterranean formation comprising:
hydraulically fracturing a subterranean formation as described according to said first aspect;
allowing an area fractured to close down whilst being propped by a proppant;
allowing or causing the viscosity of the formulation introduced to be lowered;
allowing oil to flow to the surface after the viscosity of the treatment fluid formulation has been lowered.

Any feature of any aspect of any invention or embodiment described herein may be combined with any feature of any aspect of any other invention or embodiment described herein mutatis mutandis.

Specific embodiments of the invention will now be descried, by way of example, with reference to the accompanying figures, wherein:

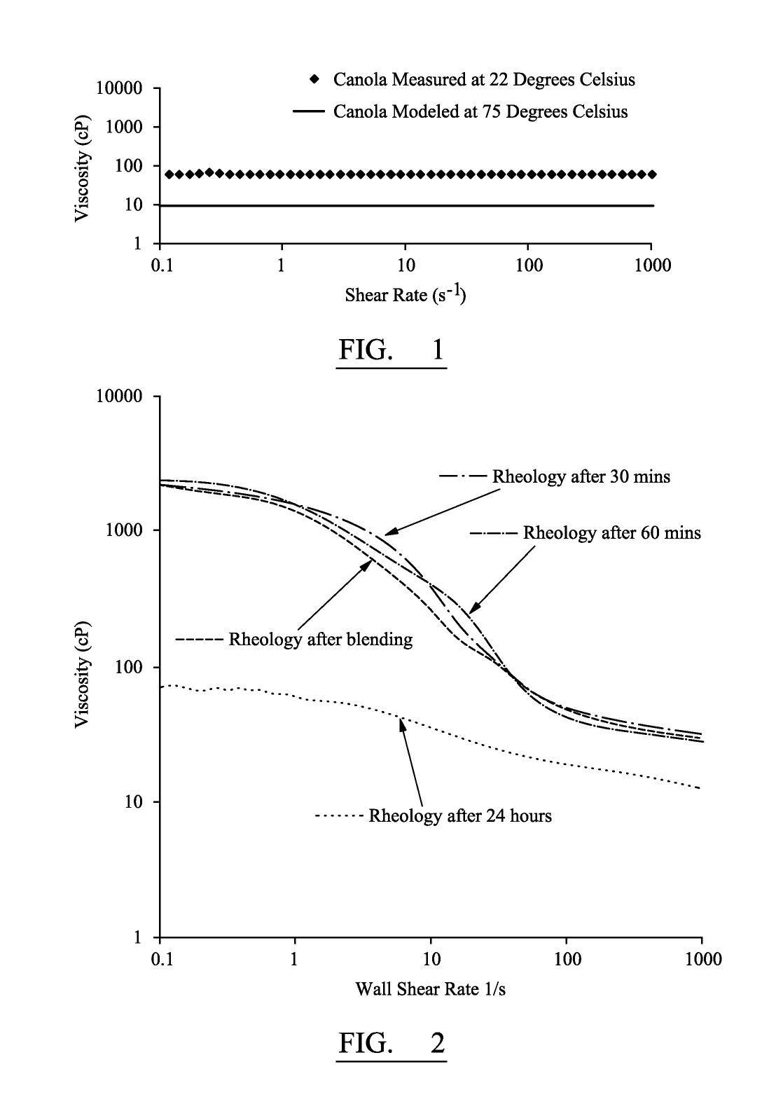

FIG. 1 is a plot of apparent viscosity (cP) v shear rate (s⁻¹) for canola oil at ambient temperature;

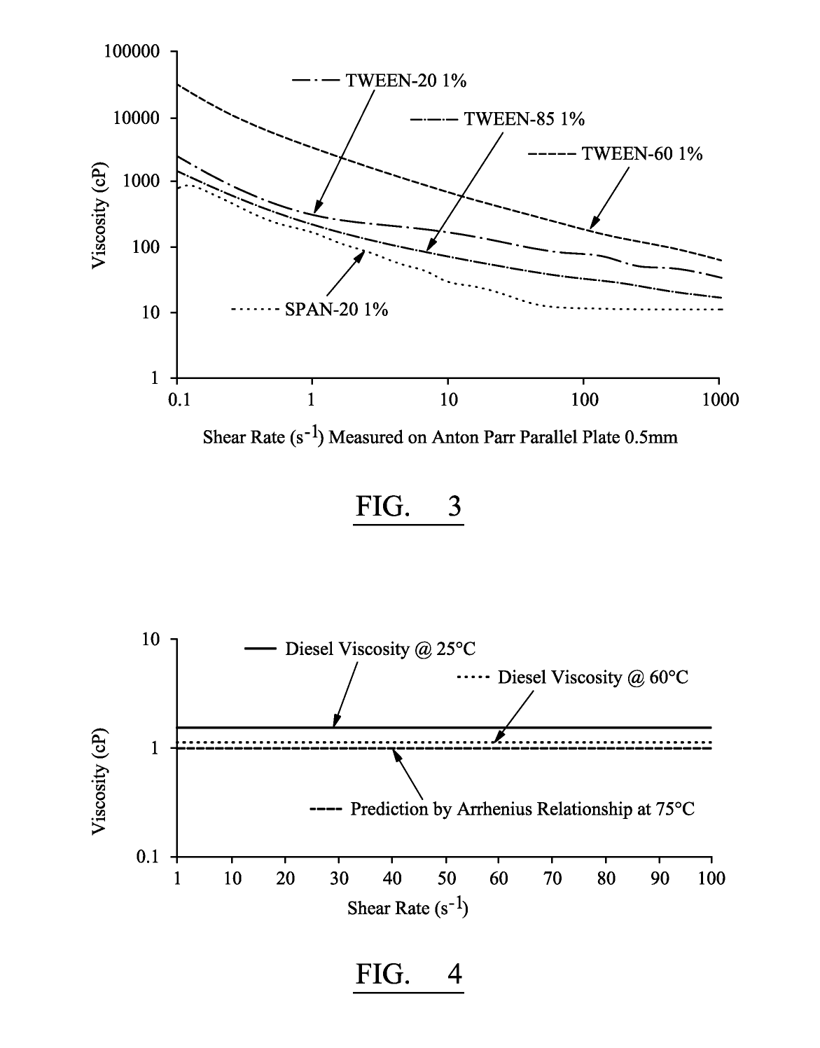

FIG. 2 is a plot showing rheology of canola and polyvinylalcohol aqueous emulsions;

FIG. 3 is a plot showing rheology of emulsions of diesel oil, polyvinylalcohol, surfactant and water;

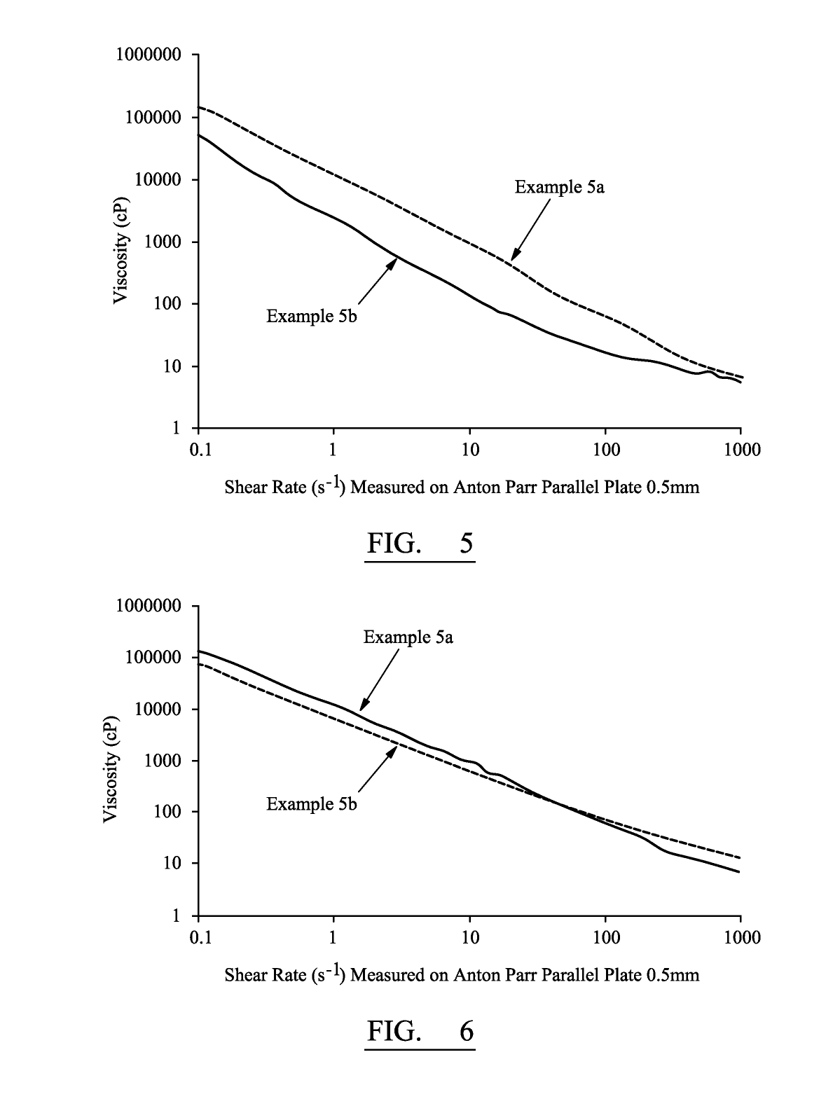

FIG. 4 shows diesel viscosity as a function of shear rate;

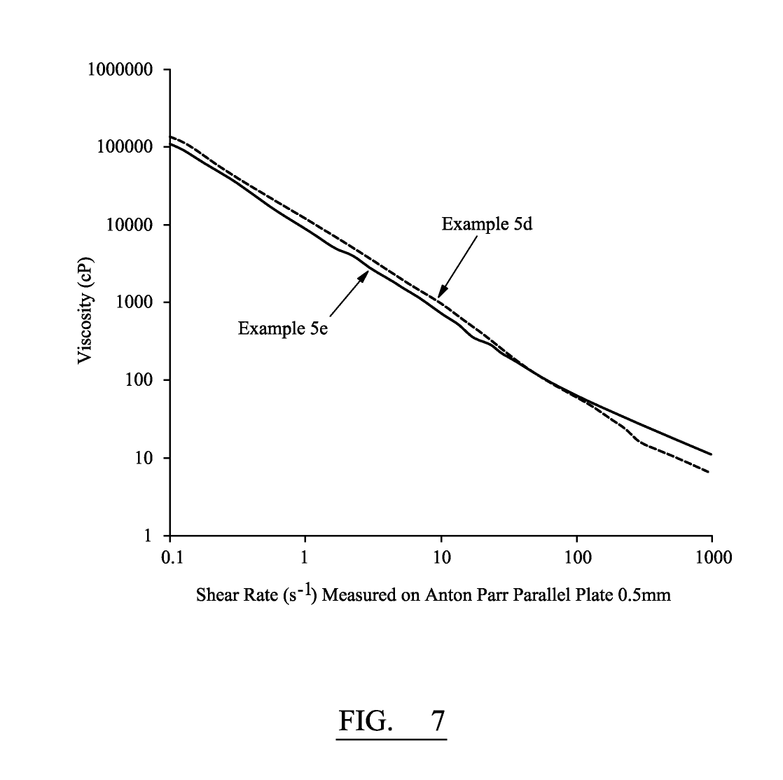

FIG. 5 is a plot showing rheology of emulsions of diesel oil, polyvinylalcohol, silica flour and water at different liquid phase ratios;

FIG. 6 is a plot showing rheology of diesel oil, polyvinylalcohol, silica flour and water at different silica ratios;

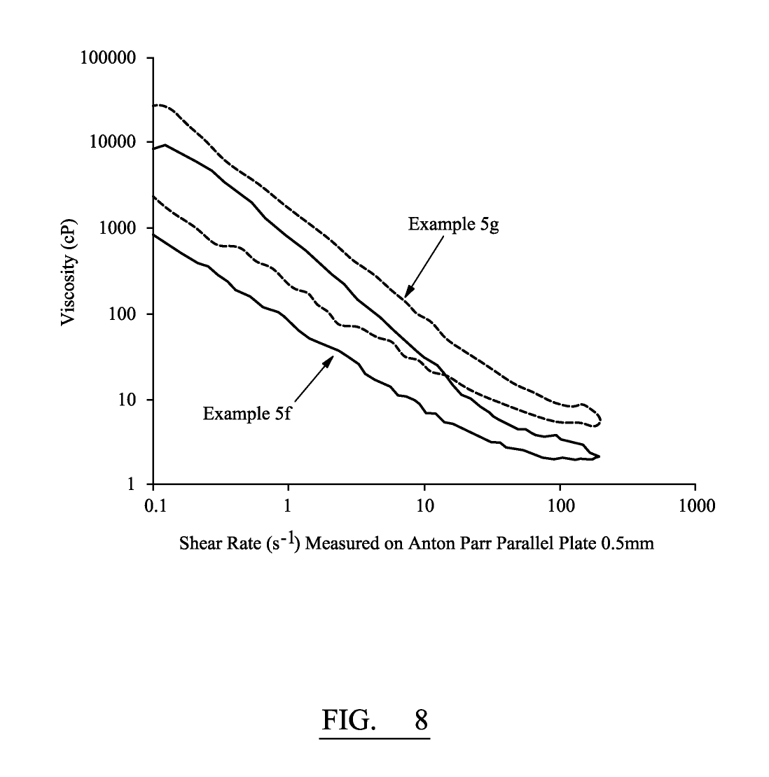

FIG. 7 is a plot showing rheology of diesel oil, polyvinylalcohol, silica flour and water at different polyvinylalcohol concentrations;

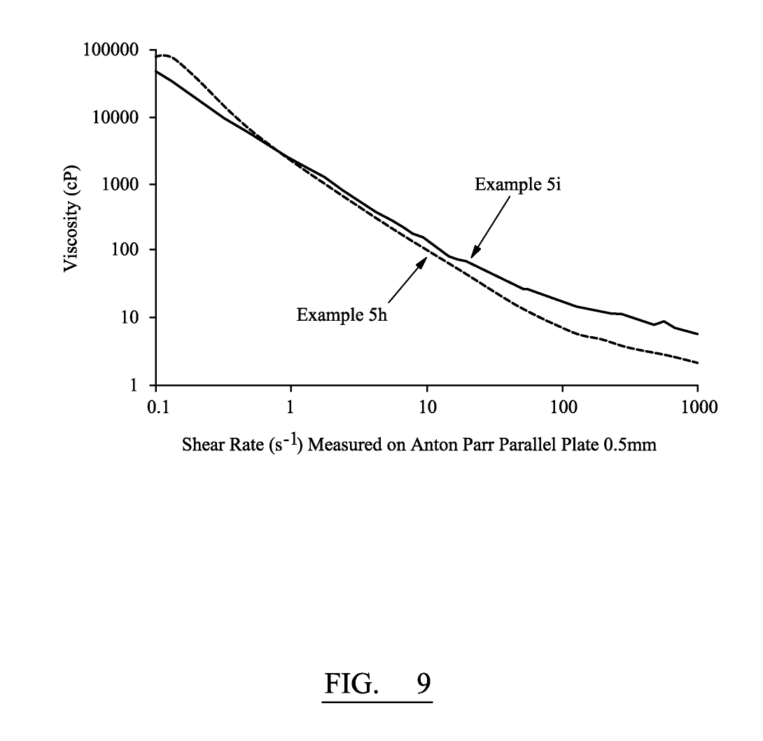

FIG. 8 is a plot illustrating shear stability of diesel oil, polyvinylalcohol, silica flour and water emulsions;

FIG. 9 is a plot comparing the rheology of water with that of an aqueous emulsion of diesel oil, polyvinylalcohol and silica flour.

The following materials are referred to hereinafter:

Polyvinylalcohol Grade A—87-89 mol % hydrolyzed polyvinylalcohol, wherein the viscosity of a 4 wt % aqueous solution at 20° C. is 3-3.7 cP which corresponds to a weight average molecular weight of about 20,000.

Silica flour—refers to silica flour grade L207A obtained from AGSCO Corporation. The flour had the following properties:

Physical Properties:

| | | |
|---|---|---|
| SPECIFIC GRAVITY | 2.65 | g/cm³ |
| LOOSE PACK BULK DENSITY | 1.28-1.36 | g/cm³ |
| MELTING POINT | 3040-3400 | ° F. |
| HARDNESS | 7 | Mohs |
| GRAIN SHAPE | Angular | |
| Acidity in distilled water | 6.8 to 7.2 | pH |

| Screen Aperture Size (Micron) | L207A |
|---|---|
| 20 | 100.0% |
| 15 | 98.5% |
| 10 | 92.0% |
| 5 | 65.2% |
| Average Particle Size | 3.9 |
| Hegman Fineness | 6+ |
| Oil Absorption (g/100 g) | 28 |

| Chemical Properties: | |
|---|---|
| SILICON DIOXIDE (SiO₂) | 99.7% |
| Iron Oxide (Fe₂O₃) | 0.022% |
| Aluminium Oxide (Al₂O₃) | 0.123% |
| Titanium Oxide (TiO₂) | 0.010% |
| Calcium Oxide (CaO) | 0.010% |
| Magnesium Oxide (MgO) | <0.010% |
| Sodium Oxide (Na₂O) | <0.010% |
| Potassium Oxide (K₂O) | <0.010% |
| Loss Ignition | 0.100% |

C2000 Frac Oil—refers to a fracture diesel oil, described as a natural gas condensate, obtained from Conoco Philips which is said to include C2-20 (100%) and ethylbenzene (<1%). The physical characteristics are stated to be as follows:

| Item Description | Min | Typical | Max | Units |
|---|---|---|---|---|
| Vapor Pressure @ 20° C. | 22 | — | 60 | mmHG |
| Vapor Density (air = 1) | — | 3.71 | — | |
| Boiling Point | 110 | — | 335 | ° C. |
| Melting Point | — | −72 | — | ° C. |
| Solubility in Water | Insoluble | | | |
| Solubility in Other Solvents | Partially soluble in Diethylether | | | |
| Partition Coefficient | No Data | | | |
| (n-octanol/water)(Kow) | | | | |
| Specific Gravity @ 15.6° C. | — | 0.785 | — | |
| Evaporation Rate | >1 | | | |
| (nBuAc = 1) | | | | |
| Flash Point | — | — | 21 | ° C. |
| Test Method | Pensky-Martins Closed Cup, | | | |
| | ASTM D-93, EPA 1010 | | | |
| LEL | — | — | 1.0 | % in air |
| UEL | — | 10.0 | — | % in air |
| Auto-ignition Temperature | — | 232 | — | ° C. |

Unless otherwise stated rheology profiles described herein were constructed using an Anton Paar MCR501 with parallel plate head set to a gap width of 0.5 mm and a plate temperature of 75° C.

“pbw”—refers to “parts by weight”.

Various fluids have been assembled and assessed for their suitability as fracture fluids as illustrated in the Examples which follow.

### EXAMPLE 1

### Assessment of Canola Vegetable Oil

The rheology profile of canola oil was constructed by measurements undertaken at ambient temperature and the viscosity of the oil at 75° C. was then modelled. FIG. 1 provides the results from which it will be seen that, at ambient temperature and pressure, the canola oil acts as a Newtonian fluid with a viscosity of approximately 60 cP. At 75° C., the canola oil was calculated to have a Newtonian viscosity of 9.5 cP.

### EXAMPLE 2

### Assessment of Formulations Comprising Canola Oil and Polyvinylalcohol Grade A

A 0.5 wt % solution of polyvinylalcohol grade A was prepared by dissolution of the powdered polyvinylalcohol in tap water at an elevated temperature with stirring to produce a concentrate which was then diluted to produce the target concentration.

Canola oil (70 pbw) and the 0.5 wt % polyvinylalcohol solution (30 pbw) were brought together in a beaker at ambient temperature and pressure. They were then sheared continuously for 1 minute using s Silverion LRT-4 blender set at 6000 rpm. The rheology of the mixture was assessed at various times after blending and the result shown in FIG. 2.

Comparing FIGS. 1 and 2, it will be noted that, when assessed within 1 hour of blending, the blend shows a significant increase in viscosity compared to the canola oil alone. For example the “consistency index” (defined as the apparent viscosity of the fluid at a shear rate of 1 s⁻¹) of the mixture is approximately 1500 cP compared to about 10 cP for the oil alone. Furthermore, it will be noted that the mixture is very stable over a period of 1 hour (confirmed by substantial similarities of the rheology profiles over this period) and that the mixture is strongly pseudoplastic and non-Newtonian. It should also be noted from FIG. 2 that, over a period of 12 hours, the mixture readily breaks down forming a lighter more flowable fluid with a consistency index of about 60 cP.

In view of the rheological properties of the mixture, it may carry proppant particles and be used as a fracture fluid. Advantageously, the mixture may exhibit reduced viscosity as it is introduced under pressure and/or high shear into the formation, facilitating its passage into the formation; the viscosity may then increase under the low shear environment and may remain relatively high for a period, thereby facilitating carrying of proppant; as the fluid slows down, its viscosity also increases (due to it being non-Newtonian); thereafter, the mixture may decompose and the viscosity may reduce thereby depositing the proppant and facilitating removal of the mixture from the formation.

### EXAMPLE 3

### Enhancing stabilization of formulations comprising diesel oil and polyvinylalcohol Grade A

Investigations were undertaken to assess how the rheology of mixtures of diesel oil and polyvinylalcohol grade A can be adjusted and/or the mixture stabilized by use of surfactants.

Diesel oil (70 pbw), polyvinylalcohol solution as per Example 2 (29 pbw) and surfactant (1 pbw) were introduced into a Warring model 7011G blender cup which was run at setting 2 (high speed) for one minute to ensure adequate mixing of components. A sample of fluid was taken using a syringe and assessed using the Anton Paar MCR501 as described. Results are presented in FIG. 3 for the following:
SPAN-20—HLB 8.6, Laurate, wetting agent
TWEEN-20 HLB 16.7, Laurate, oil in water emulsifier
TWEEN-85 HLB 11.0, Oleate, oil in water emulsifier
TWEEN-60 HLB 14.9 Stearate, oil in water emulsifier

FIG. 3 illustrates how surfactants of different types and/or HLB values may be used to adjust the rheology profile of the oil/polyvinyl alcohol formulations, making it possible to “tune” formulations to particular desired rheology profiles.

Formulations made using the TWEEN-60 surfactant result in the formation of a very strong homogenous pseudoplastic fluid. However, the rheological characteristics may be too high for the specification desired for use as a fracturing fluid. A preferred specification for the fracture fluid may be that the fluid should exhibit an apparent viscosity of 100 cP at 50 s⁻¹ and 50 cP at 100 s⁻¹. In addition, it is preferred that the viscosity of the fracture fluid does not exceed 500 cP between 50 s⁻¹ and 100 s⁻¹.

Formulations made using TWEEN-20 and TWEEN-85 result in formation of a homogenous pseudoplastic fluid with a rheological profile approximately that of the desired rheological profile.

Formulations made using the SPAN-20 surfactant formed a relatively unstable fluid that broke into its constituent parts during the measurement process which resulted in the Newtonian plateau observed in FIG. 3.

It appears from results that the preferred HLB values for surfactants are in the range 10 to 14.

### EXAMPLE 4

### Assessment of Fracture Diesel Oil

The rheology profile of a fracture oil (sold under the name C2000 FracOil by Connoco Philips) was assessed to construct rheology profiles at 25° C. and 60° C. and results are provided in FIG. 4 from which it will be seen that the fracture oil acts as a Newtonian fluid with a viscosity a little greater than 1 cP.

### EXAMPLE 5

### Assessment of Formulations Comprising Fracture Oil and Polyvinylalcohol Grade A

Formulations were prepared comprising the fracture oil of Example 4, a solution of polyvinylalcohol grade A prepared as described in Example 2 (although different concentrations were used in some experiments) and silica flour, to improve stability of the formulations.

In each case, the silica flour was thoroughly blended with the fracture oil before the polyvinylalcohol solution was blended in. To this end, the fracture oil was placed into the cup of the Warring blender and the silica flour was added to the cup and the two components briefly mixed in the blender on setting 2 for approximately 30 seconds. The polyvinylalcohol solution was added to the cup of the blender and the three components were then mixed using the blender on setting 2 for one minute. Each fluid was sampled using a syringe to remove approximately a 1 ml aliquot, the rheology of which was assessed using the Anton Paar MCR501 with a bed preheated to 75° C. for 5 minutes.

Formulations tested were as follows:

| | Formulation | | | |
|---|---|---|---|---|
| Example | Silica | Fracture Oil | | Results referred to in |
| No. | flour | (wt %) | Polyvinylalcohol detail | Figure number(s) |
| 5a | 5 wt % | 60 wt % | 35 wt % of 0.5 wt % solution | 5, 6 |
| 5b | 5 wt % | 70 wt % | 25 wt % of 0.5 wt % solution | 5 |
| 5c | 2.5 wt % | 60 wt % | 37.5 wt % of 0.5 wt % solution | 6 |
| 5d | 5 wt % | 60 wt % | 35 wt % of 0.5 wt % solution | |
| 5e | 5 wt % | 60 wt % | 35 wt % of 0.4 wt % solution | |
| 5f | 1 wt % | 70 wt % | 29 wt % of 0.5 wt % solution. | 8 |
| 5g | 1 wt % | 60 wt % | 39 wt % of 0.5 wt % solution. | |
| 5h | 5 wt % | 70 wt % | 25 wt % tap water | |
| 5i | 5 wt % | 70 wt % | 25 wt % of 0.5 wt % solution | |

Results of assessment of the examples are provided in the Figures, as follows:

FIG. 5 shows that varying the relative ratios of the hydrocarbon component to polyvinylalcohol solution gives the ability to tune the consistency index of the fluid whilst retaining similar power law behaviour. The 60% diesel system exhibited a consistency index of approximately 10,000 cP and a power law index of approximately −0.1, whilst the 70% diesel system exhibited a consistency index of approximately 1000 with the same power law index.

FIG. 6 shows the ability to tune the power law index whilst having minimal effect on the consistency index of the fluid rheological characteristics. The system assembled using 5% silica flour exhibited a consistency index of 10,000 cP and a power law coefficient of −0.1, whilst the system assembled using 2.5% silica flour exhibited a consistency index of 7000 cP and a power law coefficient of −0.01. Within the precision of measurement the consistency indices can be considered to be equivalent.

FIG. 7 shows the effects of varying the concentration of the polyvinylalcohol in solution. Within the bounds of measurement error no discernable difference is observed when changing the concentration for the active ingredient from 0.5% wt to 0.4% wt in solution of the aqueous phase.

FIG. 8 shows the effects of long term relatively low levels of shear on the solutions. Whereas during assembly significant intensity and duration of shear is desirable in order to form strong and stable emulsions, the effects of continuous but low levels of shear gradually degrades the strength of the emulsions. This is determined to be a desirable effect. During the shear regime within the delivery tubulars, the fluid will remain strong to allow adequate carriage of proppant; however as the fluid slows down and experiences much lower levels of shear in the fracture, the fluid will gradually “break” and slowly release proppant. It is believed that with correct fluid tuning, this will result in comparatively even proppant distribution within the fracture and ease of cleanup of the delivery fluid components once the fracture generation pressure is removed.

FIG. 9 shows a comparison of fracture oil emulsion assembly using polyvinylalcohol (Example 5i) with that made using tap water (Example 5h). The latter slowly disassembled during the measurement process which confirms its unsuitability for use as a fracture fluid.

### EXAMPLE 6

### Breaking of Formulations

A sample of 250 ml of a homogenised fracture fluid comprising diesel (69 wt %), polyvinylalcohol solution of Example 2 (30 wt %) and silica (1 wt %) was placed in a beaker. The beaker was placed on a laboratory bench in front of a hand drawn grid displaying dark blue lines, spaced 5 mm apart, on a white background, in order to give a visual reference of free water height. On a ten minute cycle, a 1% by volume sample of a given breaker fluid was added and gently hand stirred into the solution up to a maximum of 14%.

It was found that the following breaker fluids were able to break the fracture fluid:
water alone
polyvinylalcohol solution of Example 2
diesel alone.

Formulations described may be deployed as described below.

Potentially prior to the assembly of, or during the assembly of the proposed fracture fluid, a breaking fluid may be placed into the formation into which it is intended the cause the fracture. The purpose is to saturate the formation with the breaking agent such that, in post fracture treatment, once overburden pressure is released, the agent will be produced back into the fracture void space and blended with the fracture fluid used, initiating the breaking process of that fluid and beginning the fracture clean-up process. Alternatively, a breaker may be added either with proppant or subsequently as described below.

The fracture fluid may be assembled as follows:
The selected fracture oil is placed into a mixing vessel and agitated either by an aggressive stirring mechanism or pump recirculation from the bottom of the vessel and returning to the top of the vessel.
A combination of either surfactant, particulate or surfactant and particulate are dosed into the top of the oil phase and agitated for a defined period of time. The period will be dependant upon the degree of agitation applied but will be greater than 30 seconds and not more than 5 minutes.
A previously constructed volume of concentrate of polyvinyl alcohol solution will be added to the vessel along with a suitable volume of water as defined above to make up the solution to meet the product component specification.
Agitation will continue for a period of not less than 30 seconds and not more than 5 minutes.

A typical fracturing process may be as follows:

1. An acid stage, consisting of several thousand gallons of water mixed with a dilute acid such as hydrochloric or muriatic acid: This serves to clear cement debris in the wellbore and provide an open conduit for subsequent fracture fluid by dissolving carbonate minerals and opening fractures near the wellbore.
2. Potentially a pre fracture pad of breaking water is injected into the formation below fracture pressure. Its purpose being that post fracturing, when the well pressure is relieved, the pad of water will be released back into the fracture breaking the fracture emulsion.
3. A pad stage, consisting of sufficient fracture fluid as defined above as to cause a local reservoir overburden pressure causing the reservoir to crack opening the formation and helping to facilitate the flow and placement of proppant material.
4. A prop sequence stage, which may consist of several substages of water or fracture fluid as defined above combined with proppant material (consisting of a fine mesh sand or ceramic material, intended to keep open, or “prop” the fractures created and/or enhanced during the fracturing operation after the pressure is reduced). Proppant material may vary from a finer particle size to a coarser particle size throughout this sequence. Proppants can include but are not limited to:

1) Untreated sands

2) Filtered and cleaned sands

3) Ceramic particles

4) Resin coated sand

5) Resin coated bauxite

6) Resin coated ceramic

7) Curable ceramic

8) Curable sand

9) Pre-cured sand

10) Curable resin coated sand

11) Pre-cured sand

12) Pre-cured resin coated sand
Densities are typically 2.45 through 2.65 g/cc;
Bulk packing densities are typically in the range 1.45 through 1.8 c/cc;
Crush resistance is typically in the range 100 psi through 20000 psi;
Temperature stability up to 235° C.;
Typical Mesh sizes used range from but are not limited to 12/18, 16/20, 20/40. The first number denotes the nominal particle mesh size, the second number denotes the MESH size of the excluded fines fraction;
Typical addition rates are from nothing through to 2000 Kg of proppant material per m3 of fracture fluid.
   5. Many stages of fracture may be carried out depending on the particular job. Commonly on simple fracture jobs, fresh fracture fluid will only be used to generate a single fracture or fracture network. Much more complex interventions may implement upwards of ten repeat fracture stages, In each case, moveable isolating plugs are located before and after the fracture allowing precise location of the fracture fluid placement. It is now commonplace to implement upwards of ten multistage fractures in a single programme. Usually isolation of discrete fractures or fracture networks is made to ensure that the initiation points within the wellbore are at least 250 to 500 feet apart.

Typically the breaker will either be added at the proppant stage or immediately after depending on how the job designer requires to “switch off” the proppant carrying fluid. The flushing stage will then happen either immediately after the proppant or breaker stage depending on how quickly the proppant carrying fluid is expecting to break. Flushing is typically referred to as the “clean-up” stage. Typically, the flushing stage consists of a volume of water or breaking agent sufficient to reduce the viscosity of the fracture fluid and flush the excess proppant from the wellbore.

6. The fracture fluid and or components of the fracture fluid are produced back to surface. The oil and water phase are separated. The oil is recovered for future use. The water and excess proppant are disposed of.

As an alternative to the use of high viscosity formulations as described, slick water fracture fluid may be created by the addition of a hydrocarbon fluid to a low concentration of a polyvinyl alcohol solution in order that very small stabilized drops of hydrocarbon be formed. To aid in the creation of the droplets, an additional shearing process step may be used. This may be tuned to give droplets of different sizes.

The droplets once stabilized may be added at a very low addition rate to a bulk of rapidly moving water based fracturing fluid which may include surfactants as fluid stabilisers, corrosion inhibitors, scale inhibitors, particulate materials, biocides, pH buffers, fluid loss control additives, breaking agents and possibly polymers such as acrylamide to control the flow regime. Due to the shearing action and turbulence of the flowing water, the drops will remain at a fixed if slightly deformable size. The fluid flowing regime, in much the same way that it acts on either a surfactant additive or long chain polymer additive, will force the hydrocarbon droplets into the wall/fluid boundary layer and cause interference to the shedding of vortices and therefore cause greater pressure drop reduction per unit pipe length than would be expected for an untreated fluid.

Given that the composition of the additive is primarily hydrocarbon, the additive will be reservoir compatible. Specifically the proposed system will be hydrocarbon tuned such that an ideal degree of compatibility can be achieved. For instance, if a heavy oil reservoir wellbore is desired to be fractured, a heavy oil hydrocarbon component may be used in the preparation of the droplets. Gas hydrocarbon wells can also be fractured using the formulations described.

Given the nature of the components, that is, the polyvinyl alcohol and the hydrocarbon being anionic, the resulting additive should not be sensitive to the salinity of the water used for the fracture treatment. Also, given the very short chain polyvinyl alcohol used as one component, the additive may not be sensitive to the shear imparted by surface equipment or due to the high shear flow regimes experienced. Also, given the relatively benign nature of the polyvinyl alcohol used, the handling requirements for the raw chemicals used on the surface and in preparation will be less onerous than those required to handle surfactant additives.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-26. (canceled)

27. A method of fracturing a formation comprising:
(a) selecting a formulation comprising water and a polymeric material which includes —O— moieties pendent from a polymeric backbone;
(b) introducing the formulation into the formation at a pressure sufficient to fracture the formation.

28. A method according to claim 27, wherein said polymeric material includes a moiety

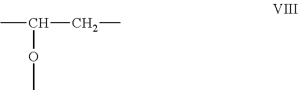

29. A method according to claim 28, wherein at least 60 mole of said polymeric material comprises repeat units which comprise moieties VIII.

30. A method according to claim 28, wherein said polymeric material comprises units of formula VIII and 20 mole % or less of other units.

31. A method according to claim 27, wherein said polymeric material includes a multiplicity of hydroxyl groups pendent from said polymeric backbone; and also includes a multiplicity of acetate groups pendent from said polymeric backbone.

32. A method according to claim 31, wherein the ratio of the number of acetate groups to the number of hydroxyl groups in said polymeric material is in the range 0 to 3.

33. A method according to claim 27, wherein said polymeric material comprises 60 to 99 mole % of vinylalcohol repeat units.

34. A method according to claim 27, wherein said polymeric material comprises 70 to 95% hydrolysed polyvinylalcohol.

35. A method according to claim 27, wherein the weight average molecular weight of said polymeric material is less than 40,000.

36. A method according to claim 27, wherein the viscosity of a 4 wt % aqueous solution of the polymeric material at 20° C. is in the range 1.5-7 cP.

37. A method according to claim 27, wherein said formulation includes one or more proppants.

38. A method according to claim 37, wherein the total weight of proppant(s) in said formulation is in the range 5 wt % to 30 wt %.

39. A method according to claim 27, wherein said formulation includes 25-60 wt % water.

40. A method according to claim 27, wherein said formulation includes an oil.

41. A method according to claim 40, wherein said formulation includes 55 to 90 wt % oil.

42. A method according to claim 40 or claim 41, wherein said oil is selected from a diesel oil and a vegetable oil.

43. A method according to claim 27, said method including the step of introducing a breaker into the formation which is arranged to destabilise the formulation introduced in step (b) and reduce its apparent viscosity, thereby facilitating its removal from the formation.

44. A method according to claim 27, the method including a step (c) which follows step (b) and comprises introducing a second formulation into the formation at a pressure sufficient to fracture the formation, wherein said second formulation comprises said polymeric material.

45. A method according to claim 27, wherein said formulation selected in step (a) comprising water and said polymeric material is used to increase the viscosity of oil which is included in said formulation.

46. A method according to claim 27, wherein said formulation comprises water, polymeric material and oil and has a consistency index at 25° C. which is at least 50 times the consistency index of the oil alone.

47. A method according to claim 27, wherein said formulation described in (a) includes less than 2 wt % of surfactants.

48. A method according to claim 27, wherein said formulation has an apparent viscosity at 25° C. and a shear rate of 1 s⁻¹ of at least 100 cP immediately prior to introduction into the formation.

49. A method according to claim 27, wherein said formulation selected in step (a) is arranged to define a slick water fracture fluid.

50. A method of preparing a formulation for use in the method of any preceding claim, the method comprising contacting an aqueous formulation of said polymeric material with an oil, optionally in the presence of one or more proppants.

51. A formulation for use in the method of claim 27, said formulation comprising water, said polymeric material, an oil and, optionally, one or more proppants.

52. A method of recovering oil from a subterranean formation comprising:
hydraulically fracturing a subterranean formation as described according to claim 27;
allowing an area fractured to close down whilst being propped by a proppant;
allowing or causing the viscosity of the formulation introduced to be lowered;
allowing oil to flow to the surface after the viscosity of the treatment fluid formulation has been lowered.
